(19) United States
(12) Patent Application Publication
(10) Pub. No.: US 2003/0212217 A1
(43) Pub. Date: Nov. 13, 2003

(54) Fluorinated activator

(76) Inventors: Suresh Sawant, Stevenson Ranch, CA (US); Bernard Morkunas, Thousand Oaks, CA (US)

Correspondence Address: Finnegan, Henderson, Farabow,, Garrett & Dunner, L.L.P., 1300 I Street, N.W., Washington, DC, 20005-3315, US

(21) Appl. No.: 10/142,564

(22) Filed: May 8, 2002

(51) Int. Cl. C08F 2/00

(52) U.S. Cl. 525/458

(57) ABSTRACT

Coating compositions and methods of making and using such coating compositions, for providing durability and repellency. The coating composition comprising a polyol, a polyisocyanate, and a fluorinated activator, optionally prepared from a polyol, a polyisocyanate and a perfluoroalkyl alcohol.

The present invention is related to coating compositions and methods for making such coatings. More particularly, the invention relates to coating compositions adapted for durability and/or repellency.

The coating compositions known in the art include, for example, polyurethane resin-based coating compositions, acrylic resin compositions, and other compositions. However, the use of these coating compositions results in disadvantages, such as a coated substrate surface which can easily be cracked or become susceptible to dust, stains, iron powder, rain, acid rain, sunlight, or other factors during exposure to weather or other environmental conditions.

Some compositions having resins with fluorinated side chains or having fluorinated resins are known to have oil and water repellant properties. Hence, coating compositions have been prepared with fluorinated acrylic resins, fluorocarbon-based resin compositions, and fluorinated acrylic resins with urethane units. However, such pervasive fluorination results in changing the properties of the entire coating composition. A coating composition is desired that embodies the desired properties of the fluorination, but maintains the properties of the bulk coating composition.

The present invention may exhibit either or both of the following desirable characteristics: durability (resistance to cracking, chipping, and/or flaking) and repellency (repellence of dust and resistance to stains and other deposits, also referred to as cleanability).

The term “coating composition” refers to any protective or decorative composition which can be applied to a substrate. Nonlimiting examples of coating compositions include a large variety of coatings known in the art including but not limited to topcoats, basecoats, primers, adhesives, sealants, and other protective and decorative compositions.

In one nonlimiting embodiment of the present invention, the coating composition comprises a film-former, a curing agent, and an activator. In one nonlimiting embodiment, the activator is formed in-situ in the curing agent. In another nonlimiting embodiment, the activator is formed in-situ in the film-former. In another nonlimiting embodiment, the activator is formed as a third component at least partially gelled prior to addition to the film-former component or the curing agent component.

The term “film-former” refers to a wide variety of materials known in the art which contain active hydrogen and make up a component of the coating composition. An example of a film-former is a polyol. The term “polyol” refers to a wide variety of materials known in the art including but not limited to multifunctional alcohol, wherein there are at least two hydroxy functional groups on the alcohol, also known as a polyhydric alcohol. The polyol can be polymeric or nonpolymeric in structure. An example of a polymeric polyol comprises a polyester structure. Another example of a film-former is an amine functional resin. Other examples of film-formers include amine functional resins, and hydroxyl functional acrylics.

The term “curing agent” refers to a wide variety of materials known in the art which at least partially gel the coating composition. An example of a curing agent is polyisocyanate. The term “polyisocyanate” refers to a wide variety of materials known in the art including but not limited to multifunctional isocyanates, wherein there are at least two NCO functional groups on the isocyanate. Polyisocyanates comprise aliphatic, cycloaliphatic, araliphatic, and aromatic polyisocyanates.

Aliphatic polyisocyanates provide an increased resistance to UV light. An example of such an aliphatic polyisocyanate suitable for use in this invention is hexamethylene diisocyanate (HDI), also known as 1,6-hexamethylene diisocyanate, 1,6-diisocyanatohexane, Mondur HX, and Desmodur H. Hexamethylene diisocyanate can be converted to a isocyanurate which is an aliphatic polyisocyanate by a simple reaction known in the art. An aliphatic polyisocyanate is a nonaromatic polyisocyanate, including without limitation OCN—(CH₂)ₙ—NCO (where n is 1 to 20), ethylene diisocyanate, trimethylene diisocyanate, tetramethylene diisocyanate, other alkylene diisocyanates, such as propylene-1,2-diisocyanate, butylene-1,2-diisocyanate, butlylene-1,3-diisocyanate, butylene-2,3-diisocyanate, alkylidene diisocyanates, such as ethylidene diisocyanate, butylidene diisocyanate cycloalkylene diisocyanates, such as cyclopentylene,-1,3-diisocyanate, cyclohexylene-1,4-diisocyanate, 4,4′-diisocyanato bis(cyclohexyl)methane; p-phenylene-2,2′-bis(ethyl isocyanate), p-phenylene-4,4′-bis (butyl isocyanate); m-phenylene-2,2′-bis(ethyl isocyanate); 1,4-naphthalene-2,2′-bis(ethyl isocyanate); 4,4′-diphenylene-2,2′-bis(ethyl isocyanate); 4,4′-diphenylene ether-2,2′-bis(ethyl isocyanate); tris(2,2′,2″-ethyl isocyanate benzene); 5-chloro phenylene-1,3-bispropyl-3-isocyanate); 5-methoxy phenylene-1,3-bis(propyl-3-isocyanate); 5-cyano phenylene-1,3-bis(propyl-3-isocyanate); and 5-methyl phenylene-1,3-bis(propyl-3-isocyanate). Typically, aliphatic polyisocyanates with similar properties as those listed above can be useful with the present invention.

Other polyisocyanates include blocked or unblocked polyisocyanates, cycloaliphatic polyisocyanates. Without limitation, examples of unblocked polyisocyanates include isophorone diisocyanate, 4,4′-methylene-bis(cyclohexyl isocyanate), and aromatic polyisocyanates. Examples of suitable blocking agents for the polyisocyanates include lower aliphatic alcohols such as methanol, ethanol, and butanol, oximes such as methyl ethyl ketoxime and other ketoximes, and lactams such as caprolactam, and other lactams known in the art.

The term “substrate” refers to any surface, whether interior or exterior onto which a coating composition can be applied including a previously at least partially coated portion of the surface. The substrate can be formed from one or more of any of a large number of materials known in the art including, but not limited to, metallic materials, non-metallic materials such as polymeric and composite materials, and combinations thereof. Exemplary metallic materials include aluminum, steel, titanium, and alloys thereof. Polymeric materials include polyurethane, nitrile or buna “N” rubbers, and fiber glass materials and composites. Other materials which form outer surfaces where it is desirable to have durability and repellency can also operate as substrates.

The coating composition of the present invention can be applied to a large variety of configurations including both planar as well as complex geometric substrates. Exemplary substrates on which the coating compositions are useful lend themselves a large variety of applications, including but not limited to, aerospace, automotive, aerodynamic, and construction surface applications. The coatings of the present invention are particularly useful as a coating for a variety of substrates such as fuselage, wings, chassis, marine vessels, etc.

For the purposes of this invention, reference to applying the coating composition to the substrate can refer to applying the coating composition directly to the substrate or over one or more coating compositions which have previously been applied to the substrate.

The term “activator” refers to a material adapted to provide a resulting coating with the desired durability and repellency. The activator can comprise functional heteroatom substitutes such as fluorine to achieve the desired durability and repellency. The activator can comprise other halides in addition to fluorine to achieve the desired properties; however, fluorine is typically used because of its greater electronegativity. The activator can be formed or reacted in-situ in either or both the film-former component or the curing agent component of the coating composition. Alternatively, the activator can be at least partially gelled prior to addition to either the film-former component or the curing agent component of the coating composition.

In certain nonlimiting embodiments, the coating composition of the present invention comprises a film-former, a curing agent, and an activator. In one nonlimiting embodiment, the film-former can be a polyol, and the curing agent can be a polyisocyanate. The coating composition has three components: (a) a polyol, (b) a polyisocyanate, and (c) an activator. The activator comprises a fluorine-functional polyurethane which is at least partially gelled. The coating composition is adapted to increase durability and repellency by adding sufficient activator. Durability and repellency are qualitative tests commonly known in the art of coatings, and can be determined quantitatively by the ASTM discussed below. The activator is adapted to increase the durability and repellency of the resulting coating composition by adding sufficient fluorine-functionality.

In one nonlimiting embodiment, the activator can be prepared from ingredients comprising a polyisocyanate, a polyol, and a fluorine-functional alcohol. Such similarity in composition between the activator and the coating components provides consistency throughout the coating composition. This is desirable because inconsistency between activator and coating components can lead to incomplete substrate protection. The polyol and the polyisocyanate in the activator can be the same material as (a) and (b) of the coating composition, respectively, or they can be different polyols and polyisocyanates. When the same materials are used, the homogeneity between activator and coating composition provides for a more uniform resulting coating composition. Alternatively, the fluorine-functional alcohol can be a polyol.

In another nonlimiting embodiment of the present invention, the activator can be formed in-situ in the curing agent component of the coating composition. The curing agent can be, for example, polyisocyanate. In this embodiment, the activator is formed in-situ in the polyisocyanate component by adding a polyol and a fluorine-functional alcohol to the polyisocyanate component. The polyisocyanate component can then be mixed with the polyol component forming the resulting coating composition.

In further nonlimiting embodiment of the present invention, the activator can be formed in-situ in the film-former component of the coating composition. Here, the film-former can be, for example, a polyol. In this embodiment, the activator is formed in-situ in the polyol component by adding a polyisocyanate and a fluorine-functional alcohol to the polyol component. The polyol component can then be mixed with the polyisocyanate component forming the resulting coating composition.

In a still further nonlimiting embodiments, the polyol comprises at least two hydroxyl functional groups. Two typical commercially available polyols are (1) CAPA® 316 or CAPA® 3022 (Solvay, S. A.; Brussels, Belgium) which is made from caprolactones such as 2-oxepanone, and (2) K Flex® 188 (King Industries, Inc.; Norwalk, Conn.) which is made from cyclohexane dimethanol and other polyester based polyols having the formula HO—[—R(OH)ₚ—O—CO—(CH₂)ₘ—CO—O—]_{q}—R—(OH)ₚ₊₁ where R is a moiety derived from a saturated aliphatic polyhydric alcohol, q is 1 or 2, p is 0 to 4 inclusive, and m is 2 to 10 inclusive. The polyol can also comprise other polyols including polyester polyols, polyether polyols, as well as diols or triols such as ethylene glycol, propylene glycol, butylene glycol, glycerol, and trimethylolpropane. The polyol can also comprise nonlinear, branched polyols.

In some embodiments, the polyisocyanate comprises at least two isocyanate functional groups. Typically available polyisocyanates include: (1) Desmodur® 3390 (Bayer Corporation, Coatings and Colorants; Pittsburgh, Pa.), and (2) Tolonate® HDT-90 (Rhodia Industrial Coatings, Cranbury, N.J.), which are aliphatic polyisocyanates based on HDI containing isocyanurate. These are particularly useful with the polyols discussed above.

In some embodiment, the coating composition comprises 0.01% to 10% by weight of the activator. In other embodiments, the coating composition comprises 0.05% to 3% by weight of activator. In other embodiments, the coating composition comprises 2% to 10% by weight of activator. These fractions of activator can apply to either embodiments where the activator is at least partially ungelled prior to adding to a component of the coating composition or where the activator is formed in-situ in a component of the coating composition.

In certain embodiments, the activator comprises fluorine-functional alcohol such as a perfluoroalkyl alcohol. The perfluoroalkyl alcohol can have the structure C_{y}F_{2y+1}(CH₂)ₓOH where x is 1 to 12, and y is 3 to 20. In other embodiments, the perfluoroalkyl alcohol comprises 1H,1H,2H,2H-perfluorooctanol (Strem Chemicals, Inc.; Newburyport, Mass.). Linearity in the perfluoroalkyl alcohol is desired when the intent is to achieve durability and repellency. Nevertheless, the fluorine-functional alcohol can comprise branched or cyclic structures and still maintain an overall linearity.

In certain embodiments, the fluorine-functional alcohol comprises a perfluoroalkyl alcohol, whereby the activator comprises 0.1% to 10% by weight of this perfluoroalkyl alcohol. In other embodiments, the activator comprises 0.1% to 2% by weight of perfluoroalkyl alcohol. In still other embodiments, the activator comprises 2% to 10% by weight of perfluoroalkyl alcohol. An example of the perfluoroalkyl alcohol is 1H,1H,2H,2H-perfluorooctanol. These amounts of perfluoroalkyl alcohol apply to embodiments where the activator is at least partially gelled prior to adding to a component of the coating composition and where the activator is formed in-situ in a component of the coating composition. In embodiments where the activator is at least partially gelled and where the fluorine-functional alcohol is a perfluoroalkyl alcohol, the structure of the activator prior to adding to another component of the coating composition is (OCNR)ᵣNHCOO(CH₂)₂(CF₂)ₛF (r is 1 to 10, R is any aliphatic, cycloaliphatic, araliphatic, or aromatic alkyl group, and s is 1 to 6).

In one nonlimiting embodiment, a method for making a coating composition comprises: (a) contacting a first quantity of polyisocyanate with a perfluoroalkyl alcohol; (b) contacting the first quantity of polyisocyanate with a first quantity of polyol; (c) at least partially gelling the first quantity of polyisocyanate and the first quantity of polyol to form a first quantity of fluorine-functional polyurethane; (d) contacting the fluorine-functional polyurethane with a second quantity of polyisocyanate; and (e) contacting said second quantity of polyisocyanate with a second quantity of polyol to form the coating composition. In another embodiment, a method for making a coating composition comprises contacting the fluorine-functional polyurethane with a second quantity of polyol, and contacting the second quantity of polyol with a second quantity of polyisocyanate to form the coating composition. In either embodiment, the gelling process for the fluorine-functional polyurethane comprises maintaining the first quantity of polyisocyanate and the first quantity of polyol, for example, at 50-80° C. for 2 to 4 hours.

In another nonlimiting embodiment, a method for making a coating composition comprises contacting a first quantity of polyisocyanate with a perfluoroalkyl alcohol, contacting the first quantity of polyisocyanate with a first quantity of polyol forming an in-situ activator, and contacting said first quantity of polyisocyanate with a second quantity of polyol to form the coating composition. Alternatively, an exemplary method for making a coating composition comprises contacting a first quantity of polyol with a perfluoroalkyl alcohol, contacting the first quantity of polyol with a first quantity of polyisocyanate forming an in-situ activator, and contacting said first quantity of polyol with a second quantity of polyisocyanate to form the coating composition.

In certain nonlimiting embodiments, the coating composition can further comprise at least one additive chosen from pigments, plasticizers, fillers, adhesion promoters, solvents, and mixtures thereof. These additives are not necessary for purposes of durability and repellency, but can be added for other purposes. Pigments include a wide variety of materials known in the art including, but not limited to, organic pigments and inorganic pigments such as carbon black or metal oxides such as iron oxide and titanium dioxide. In some embodiments, the pigment will comprise 3 to 6 weight percent of the total weight of the coating composition. When the coating composition is a two component system, different colored pigments can be added to each component in order to facilitate mixing.

The coating composition of the present invention can be used in conjunction with other layers of coatings. For example, the coating composition can be applied as a topcoat. Alternatively, other layers can be applied to the substrate such as base coats, primers, and other intermediary layers. In embodiments which use multiple compositions, differently colored pigments impart different coloration to the coating composition of the present invention relative to other coatings to facilitate complete coverage.

Fillers include a wide variety of materials known in the art including but not limited to carbon black, calcium carbonate, titanium dioxide, and fumed silica. In certain nonlimiting embodiments, the fillers can comprise 20 to 30 weight percent of the total weight of the coating composition.

Adhesion promoters include a wide variety of materials known in the art including but not limited to silanes, phenolics, titanates, and epoxies. In certain nonlimiting embodiments, the adhesion promoters can comprise 2 to 5 weight percent of the total weight of the coating composition. In other embodiments, solvents useful in the present invention comprise a wide variety of materials known in the art including, but not limited to, solvents, such as ketones added to lower viscosity and facilitate application.

The durability of the coating composition can be measured by the reverse impact or the tensile strength of the coating. The coating composition of the present invention provides coats with 70 in/lbs (392 cm/kg) reverse impact resistance measured according to ASTM-D-2794, which is incorporated herein by reference. In some embodiments, the coating composition of the present invention provides coats with tensile strength from 1000 to 3000 pounds per square inch (70-120 kg/cm³) and percent elongation from 500% to 1000% at a coating thickness of 50 mils (1.27 mm) measured according to ASTM-D-412-617, which is incorporated herein by reference. The term “tensile strength” refers to the maximum resistance to deformation of a material based upon the undeformed area of the material as measured by ASTM-D-412-617. The term “elongation” means the maximum permanent strain prior to fracture of a material as measured by ASTM-D-412-617.

In other embodiments, the coating composition of the present invention can contain a wide variety of other materials adding to the film-forming capability of the coating composition including, but not limited to, one or more polythioether materials. The polythioether is typically liquid at ambient temperature and pressure. Examples of suitable polythioethers include PERMAPOL P-3-855 and other similar polymers polymers which are commercially available from PRC DeSoto International, Burbank, Calif.

The coating composition can be applied to the substrate by spray, brush, roller, or conventional fill and drain techniques to a dry thickness of 10 mils (0.25 mm) to 30 mils (0.76 mm), or 10 mils (0.25 mm) to 20 mils (0.50 mm). The coating composition can be gelled (the term “gelled” refers to curing and/or drying) in a wide variety of methods known in the art including, but not limited to, moisture, ambient, and thermal curing, such as by baking with the cure temperature ranging from 10 C. to 100 C.

In other embodiments, the coating is gelled at room temperature (25 C.). Under such conditions, the coating becomes almost completely gelled after the passage of a two-week period of time.

The specific examples below are not intended to be limiting, but demonstrative of the invention.

### EXAMPLES

A nonlimiting example of the present invention comprised taking a five liter, four-neck flask was equipped with a nitrogen blanket and adding 2372.67 grams of Desmodur® N-3390. The flask was heated to 60 C. over a two-hour period of time. When the temperature was achieved, 46.0 grams of 1H,1H,2H,2H perfluorooctanol was added to the flask. The flask contents were stirred for six hours at a temperature of 60 C. At the end of six hours, the flask is cooled to 35 C. and poured under the nitrogen blanket into storage containers. The properties of the resulting material were a viscosity of 11 poise, a weight percent of isocyanate of 18.16%, a weight per gallon 9.38 lbs. (4.26 kg), and color according to the Gardner test of less than two.

Table 1 represents several other possible examples of polyisocyanates which can represent the features of the present invention. The columns represent different high solids HDI based polyisocyanates in the Desdomur® line.

TABLE I

| | | | | | | | TP LS | |
|---|---|---|---|---|---|---|---|---|
| Desmodur-> | N3390 | N3300 | N3400 | XP-7100 | N3600 | N3790 | 2294 | XP-2410 |
| % Solids | 90 | 100 | 100 | 100 | 100 | 90 | 100 | 100 |
| % NCO | 19.4 | 21.5 | 22.0 | 20.5 | 23.5 | 17.5 | 23.3 | 24.0 |
| Viscosity @ | 550 | 3300 | 200 | 1000 | 1000 | 2000 | 900 | 600 |
| 25° C. (mPA) | | | | | | | | |

Table 2 represents several other possible examples of polyisocyanates which can represent the features of the present invention. The columns represent different solvent borne polyisocyanates in the Tolonate® line.

TABLE 2

| | | | HDB- | HDB- | | | | | HDT- | XIDT | |
|---|---|---|---|---|---|---|---|---|---|---|---|
| Tolonate-> | D2 | HDB | 75B | 75BX | HDB-LV | HDT | HDT-90 | HDT-LV | LV2 | 70B | XIDT 70SB |
| % Solids | 75 | 100 | 75 | 75 | 100 | 100 | 90 | 100 | 100 | 70 | 70 |
| % NCO | 11.2 | 22.0 | 16.5 | 16.5 | 23.5 | 22.0 | 19.8 | 23.0 | 23.0 | 12.3 | 12.3 |
| Viscosity @ | 3250 | 9000 | 150 | 150 | 2000 | 2400 | 500 | 1200 | 700 | 600 | 1000 |
| 25° C. (mPA) | | | | | | | | | | | |

It is noted that, as used in this specification and the appended claims, the singular forms “a,” “an,” and “the” include plural referents unless expressly and unequivocally limited to one referent. Thus for example, reference to “a polyol” includes two or more polyols, but “CₙF₂ₙ₊₁(CH₂)ₓOH where x is 1 to 12, and n is 3 to 20” means that x and n can only be one integer for each species. Also noted that as used herein, the term “polymer” is meant to refer to oligomers, homopolymers, and copolymers.

For the purposes of this specification and appended claims, unless otherwise indicated, all numbers expressing quantities of ingredients or percentages or proportions of other materials, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

What is claimed is:

1. A composition comprising:
(a) a polyol;
(b) a polyisocyanate; and
(c) an activator comprising a fluorine-functional polyurethane, said activator adapted to increase durability and repellency of said composition when the composition is coated on a substrate.

2. A composition according to claim 1, wherein said activator is prepared from components comprising a polyisocyanate, a polyol, and a fluorine-substituted alcohol.

3. A composition according to claim 2, wherein the polyol and the polyisocyanate in said activator comprise at least one of the same polyol and polyisocyanate as in (a) and (b).

4. A composition according to claim 2, wherein the polyol and the polyisocyanate in said activator are different from the polyol and polyisocyanate as in (a) and (b).

5. A composition according to claim 1, wherein said polyisocyanate (b) comprises at least one polyisocyanate chosen from an aliphatic polyisocyanate, a cycloaliphatic polyisocyanate, an araliphatic polyisocyanate, and an aromatic polyisocyanate.

6. A composition according to claim 1, wherein said polyisocyanate in said activator comprises an aliphatic polyisocyanate.

7. A composition according to claim 1, wherein said fluorine-functional alcohol comprises a perfluoroalkyl alcohol.

8. A composition comprising:
a polyol, wherein said polyol comprises an activator adapted to increase durability and repellency of said composition; and
a polyisocyanate.

9. A composition according to claim 11, wherein said activator comprises a fluorine-functional alcohol.

10. A composition according to claim 12, wherein said fluorine-functional alcohol comprises a perfluoroalkyl alcohol.

11. A composition comprising:
a polyol; and
a polyisocyanate, wherein said polyisocyanate comprises an activator adapted to increase durability and repellency of said composition,

12. A composition according to claim 8, wherein said activator comprises a fluorine-functional alcohol.

13. A composition according to claim 12, wherein said fluorine-functional alcohol comprises a perfluoroalkyl alcohol.

14. A composition according to claim 10, wherein:
said perfluoroalkyl alcohol comprises 1H, 1H,2H,2H-perfluorooctanol.

15. A composition according to claim 8, wherein said polyol is made from at least one precursor chosen from caprolactone and cyclohexane dimethanol.

16. A composition according to claim 8, wherein:
said polyisocyanate comprises isocyanurate.

17. A composition according to claim 8, wherein said activator comprises 0.01% to 10% by weight of said composition.

18. A composition according to claim 8, wherein said activator comprises 0.05% to 3% by weight of said composition.

19. A composition according to claim 8, wherein said activator comprises 2% to 10% by weight of said composition.

20. A composition according to claim 8, wherein said polyisocyanate is prepared from at least one hexamethylene diisocyanate.

21. A composition prepared from ingredients comprising:
a polyol;
a polyisocyanate; and
a perfluoroalkyl alcohol,
wherein said composition is activator for addition into a component of a coating, and wherein said activator is at least partially gelled.

22. A composition activator according to claim 21, wherein said perfluoroalkyl alcohol comprises 0.01% to 10% by weight of said activator.

23. A method for making a composition comprising:
(a) contacting a first quantity of polyisocyanate with a perfluoroalkyl alcohol;
(b) contacting said first quantity of polyisocyanate with a first quantity of polyol;
(c) at least partially gelling said first quantity of polyisocyanate and said first quantity of polyol to form a quantity of polyurethane;
(d) contacting said quantity of polyurethane with a first component of said composition; and
(e) contacting said component of the composition with a second component of said composition.

24. A method for making a composition according to claim 23, wherein:
said first component is a polyisocyanate and said second component is a polyol.

25. A method for making a composition according to claim 23, wherein:
said first component is a polyol and said second component is a polyisocyanate.

26. A method for making a composition comprising:
contacting a perfluoroalkyl alcohol with a first component of the composition;
contacting said first component of the composition with a second component of the composition.

27. A method for making a composition according to claim 26, wherein:
said first component is a polyisocyanate and said second component is a polyol.

28. A method for making a composition according to claim 26, wherein:
said first component is a polyol and said second component is a polyisocyanate.
